(19) United States
(12) Patent Application Publication
(10) Pub. No.: US 2011/0268651 A1
(43) Pub. Date: Nov. 3, 2011

(54) METHOD AND APPARATUS FOR STORING AND DELIVERING HYDROGEN

(75) Inventors: Alan Charles Cooper, Macungie, PA (US); Robert Gregory Wolf, Hackettstown, NJ (US)

(73) Assignee: AIR PRODUCTS AND CHEMICALS, INC., Allentown, PA (US)

(21) Appl. No.: 12/772,860

(22) Filed: May 3, 2010

(51) Int. Cl. C01B 3/02; H01M 8/06; B01J 19/00

(52) U.S. Cl. 423/648.1; 422/198; 429/416; 422/620; 422/625

(57) ABSTRACT

An apparatus and method for storing and releasing hydrogen is disclosed. In one embodiment, the apparatus includes a reactor, a heater having a first portion that is located in the reactor; a dehydrogenation catalyst that is affixed to the first portion of the heater; a hydrogen release conduit in communication with the reactor; a chamber containing a hydrogenated carrier; and an energy source coupled to the heater.

### BACKGROUND OF THE INVENTION

The invention relates to the field of hydrogen storage systems and process for the controlled release of stored hydrogen from a liquid or solid carrier for use as a fuel source.

Hydrogen can be stored as a compressed gas, as liquid hydrogen at cryogenic temperatures, and captured in various carrier media, examples of which are metal hydrides, high surface area carbon materials and metal-organic framework materials as disclosed. In metal hydrides, the hydrogen is dissociated and absorbed while for the latter two material classes, which have only demonstrated significant capacities at low temperatures, the hydrogen molecule remains intact on adsorption. Generally, the hydrogen in solid-state adsorbents can be released by raising the temperature and/or lowering the hydrogen pressure. The release of hydrogen is an endothermic process, i.e., one which requires an input of heat, at a temperature where the dehydrogenation of the carrier can proceed with adequate reaction rates.

The prior art teaches storing Hydrogen by means of a catalytic reversible hydrogenation of unsaturated, usually aromatic, organic compounds such as benzene, toluene or naphthalene. The utilization of organic hydrogen carriers, sometimes referred to as “organic hydrides”, for hydrogen storage and delivery has been described in the context of a hydrogen powered vehicle. Other examples of the dehydrogenation of organic hydrogen carriers are the dehydrogenation of decalin under “wet-dry multiphase conditions,” and dehydrogenation of methylcyclohexane to toluene. The dehydrogenation of a cyclic alkane (e.g. decalin) to the corresponding aromatic compound (naphthalene) is an endothermic reaction requiring an input of heat, which is the dehydrogenation reaction enthalpy.

Attempts have been made to provide some of the required dehydrogenation reaction enthalpy from the engine's exhaust system and the remainder by combustion of hydrogen gas. The prior art also teaches spraying a hydrogenated carrier on a resistively heated surface that incorporates a metal catalyst. This approach results in the generation of hydrogen and vaporized carrier that must be separated using a condenser. The use of condensers, pumps, and spray nozzles add complexity, weight, and mass to the hydrogen storage system.

There is a need for a hydrogen storage device that can efficiently and simply utilize a carrier to provide hydrogen of suitable purity for use in a fuel cell.

### BRIEF SUMMARY OF THE INVENTION

In one respect, the invention comprises an apparatus comprising a reactor; a heater having a first portion that is located in the reactor; a dehydrogenation catalyst that is affixed to the first portion of the heater; a hydrogen release conduit in communication with the reactor; a chamber containing a hydrogenated carrier; and an energy source coupled to the heater.

In another respect, the invention comprises an apparatus comprising a reactor containing a heating element and a dehydrogenation catalyst; a chamber containing a hydrogenated carrier; a hydrogen release conduit in communication with the reactor and a fuel cell; and an electrical connection between the fuel cell and the heating element.

In yet another respect, the invention comprises a method comprising the steps of: a) supplying a hydrogenated carrier to a reactor containing a dehydrogenating catalyst and a heater; and b) dehydrogenating the hydrogenated carrier by heating the heater to a temperature above 100 degrees Celsius in the presence of a dehydrogenating catalyst.

### BRIEF DESCRIPTION OF SEVERAL VIEWS OF THE DRAWINGS

The foregoing summary, as well as the following detailed description of the invention, will be better understood when read in conjunction with the appended drawings. For the purpose of illustrating the invention, there is shown in the drawings certain embodiments of the present invention. It should be understood, however, that the invention is not limited to the precise arrangements and instrumentalities shown. In the drawings:

FIG. 1 is a schematic diagram showing a first example of a cartridge in accordance with the present invention;

FIG. 2 is a schematic diagram showing a second example of a cartridge in accordance with the present invention, including a heater having an interior channel;

FIG. 3 is a schematic diagram showing a third example of a cartridge in accordance with the present invention, including multiple hydrogen release openings;

FIG. 4 is a schematic diagram of a device that comprises a resistively heated catalyst-containing structure within a insulating tube;

FIG. 5 is a schematic diagram of a device that comprises multiple reservoirs for a carrier, means for conveyance of carrier through a catalyst-containing structure, and a void for separation of hydrogen from the carrier;

FIG. 6 is an enlarged view of the means for conveyance of carrier through a catalyst-containing structure, and a void for separation of hydrogen from the carrier of the device illustrated in FIG. 5; and

FIG. 7 is a schematic diagram of a cartridge in accordance with the present invention, including a chamber for removing hydrogen from the carrier, separate from the carrier reservoir.

### DETAILED DESCRIPTION OF THE EMBODIMENTS OF THE INVENTION

In describing the embodiments of the invention illustrated in the drawings, specific terminology will be used for the sake of clarity. However, the invention is not intended to be limited to the specific terms so selected, it being understood that each specific term includes all technical equivalents operating in similar manner to accomplish similar purpose. It is understood that the drawings are not drawn exactly to scale.

As used in the specification and claims, the term “in communication” is intended to mean that two or more elements are connected (either directly or indirectly) in a manner that enables fluids to flow between the elements, including connections that may contain valves, gates or other devices that may selectively restrict fluid flow.

To aid in describing the invention, directional terms may be used in the specification and claims to describe portions of the present invention (e.g., upper, lower, left, right, etc.). These directional terms are merely intended to assist in describing and claiming the invention and are not intended to limit the invention in any way.

In the claims, letters are used to identify claimed steps (e.g. a), b), c)). These letters are used to aid in referring to the method steps and are not intended to indicate the order in which claimed steps are performed, unless and only to the extent that such order is specifically recited in the claims. Reference numerals that are introduced in the specification in association with a drawing figure may be repeated in one or more subsequent figures without additional description in the specification in order to provide context for other features.

The instant invention relates to hydrogen storage devices and processes of releasing the stored hydrogen from liquid or solid hydrogen carrier compositions contained within the device.

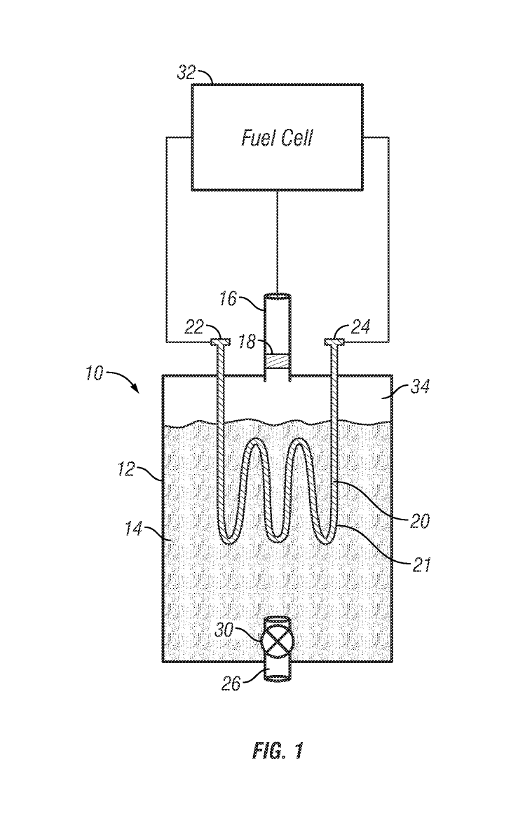

An exemplary embodiment of a cartridge 10 according to an exemplary embodiment of the present invention is shown in FIG. 1. The cartridge 10 includes a chamber, 12, a hydrogen release conduit 16 located inside the chamber 12, a membrane 18, a heater 20, negative and positive terminals 22, 24, and a carrier drain 26. Suitable materials for construction of the cartridge 10 include, but are not limited to, plastic (e.g. PET) and metal (e.g. stainless steel).

The chamber 12 contains a hydrogenated carrier 14. The chamber 12 preferably includes a valve 30, so that the chamber 12 can be filled with the carrier 14 and so that dehydrogenated carrier can be removed from the chamber 12 through the drain 26 after the cartridge 10 has been used. In this example, the carrier 14 is a liquid, but it could be provided in solid form in other embodiments.

The hydrogenated carrier 14 is preferably a carrier that is adapted to release hydrogen (dehydrogenate) only in the presence of the catalyst 21 and at a temperature that is higher than that expected maximum operating temperature for the cartridge 10. In this example, the maxium expected operating temperature for the cartridge 10 is 100 degrees Celsius and the hydrogenated carrier 14 does not release hydrogen until it is heated to about 180 degrees Celsius.

In this example, the hydrogenated carrier 14 is selected from the group consisting of: hydrocarbons, cyclic hydrocarbons, organic liquids and solutions, molten salts and ionic liquids. Preferably, the hydrogenated carrier 14 is selected from the group consisting of: large polycyclic aromatic hydrocarbons, polycyclic aromatic hydrocarbons with nitrogen heteroatoms, polycyclic aromatic hydrocarbons with oxygen heteroatoms, polycyclic aromatic hydrocarbons with alkyl, alkoxy, ketone, ether or polyether substituents, pi-conjugated molecules comprising 5 membered rings, pi-conjugated molecules comprising six and five membered rings with nitrogen or oxygen hetero atoms, and extended pi-conjugated organic polymers.

In this example, the catalyst 21 is preferably a metal and, more preferably, is selected from the group consisting of: platinum, palladium, silicides, and photo-chemically etched, doped silicon. An exemplary catalyst may be a 10% palladium on alumina catalyst.

U.S. Pat. No. 7,101,530, issued Sep. 5, 2006, U.S. Pat. No. 7,351,395, issued Apr. 1, 2008 and U.S. Pat. No. 7,429,372, issued Sep. 30, 2008, each of which are incorporated herein by reference as if fully set forth, disclose examples of hydrogenated carriers and catalysts suitable for use with the cartridge 10, as well as methods for hydrogenating and dehydrogenating such carriers.

In this example, the hydrogen release conduit 16 is in communication with an energy supply, such as a fuel cell 32 (shown schematically in FIG. 1). In other examples, other types of hydrogen-consuming devices could be used. The membrane 18 is preferably a hydrogen-permeable and liquid non-impermeable material, such as palladium or porous silica. Its purpose is to prevent the liquid from passing through the hydrogen release conduit 16. An absorbent, such as activated carbon (not shown) for example, could be used instead of or in addition to the membrane 18 for the purpose of separating carrier vapor or entrained carrier from the hydrogen stream.

In this example, the heater 20 is a resistive heating element and is preferably coated on its outer surface (i.e., the surface that will come in contact with the hydrogenated carrier 14) with a dehydrogenation catalyst 21. The negative and positive terminals 22, 24 of the heater 20 are connected to the fuel cell 32, which provides the electricity needed to heat the heating element.

Alternatively, other energy sources could be used by the heater 20 to generate heat. For example, the heat could be supplied to the chamber 12 by utilization of waste heat from the fuel cell 32 or catalytic combustion of hydrogen using ambient air. More generally, heat sources could include electrical, chemical reactions, friction, acoustic, optical or thermal via combustion, and heat transfer sources. Exemplary chemical reactions may include, but are not limited to, the combustion of hydrogen using ambient air, a catalytic reaction combining permeated hydrogen with oxygen where the oxygen may come from air or an ion transport membrane (not shown), or a chemical reaction such as the decomposition of hydrogen peroxide, the oxidation of the carrier with ambient air, the oxidation of the carrier 14 with oxygen where the oxygen may come from air or an ion transport membrane or a chemical reaction such as the decomposition of hydrogen peroxide. The oxygen may be generated in an independent reactor (not shown) where a fluid is sprayed onto a catalyst by acoustic, MEMS (Micro-Electro-Mechanical Systems) or other means to thermally or chemically decompose and produce oxygen. The oxygen from the decomposition is reacted with hydrogen using a catalyst to generate the heat to promote the dehydrogenation of the carrier 14. Additionally, water evolved from the first reaction may be used to humidify the fuel cell 32.

In embodiments in which the energy source is heat, as opposed to electricity, the heater 20 could include a conduit that circulates gas or liquid from the energy source through the chamber 12. In addition, the heater 20 could be configured as a heat exchanger for both heat and electricity-based energy sources. In the example shown in FIG. 1, most of the heater 20 is positioned within the chamber 12 (which also functions as a reactor in this example). In other embodiments, such as embodiments in which the heater 20 is a heat exchanger, a substantial portion of the heater 20 may be located outside the reactor.

Upon demand for hydrogen by the fuel cell 32, the fuel cell 32 passes electrical current through the negative and positive terminals 22, 24, which heats the heater 20 and the dehydrogenation catalyst 21 contained thereon. As noted above, in this example, the heater 20 locally heats the hydrogenated carrier 14 to between about 180 degrees Celsius and about 240 degrees Celsius.

The generated heat, in the presence of the catalyst 21, causes dehydrogenation of the portion of the hydrogenated carrier 14 that is in contact with or in proximity to the dehydrogenation catalyst 21. Hydrogen evolved from the hydrogenated carrier 14 then bubbles up through the hydrogenated carrier 14 to a head space 34 in the chamber 12 and passes through the membrane 18 in the hydrogen release conduit 16 to the fuel cell 32. The hydrogen generated from the dehydrogenation reaction can be separated from the hydrogenated carrier 14 by gravity (bubbling of hydrogen from the carrier). Additionally, a bed of adsorbent (for example, activated carbon, not shown) can be used to separate carrier vapor or entrained carrier from the hydrogen stream.

The chamber 12 may incorporate a means for engaging the hydrogenated carrier 14 with the catalyst 21. Exemplary means include reducing the size of the chamber 12 as hydrogen is released from the hydrogenated carrier 14, such as, for example by a collapsible bladder that reduces the size of the chamber 12. Alternatively, a pump may be used to pump the hydrogenated carrier 14 to or across the catalyst 21. Still other means for engaging the hydrogenated carrier 14 with the catalyst 21 may include gravity, convection, diffusion, thermal pumping, acoustic transport or bubble-induced flow. The means for moving the hydrogenated carrier 14 within the cartridge 10 can also be used to withdraw spent carrier from the chamber 12 and to recharge the chamber 12 with new hydrogenated carrier 14.

While some of the energy generated by the hydrogen in the fuel cell 32 is used to heat the heater 20, a remaining part of the energy may be used for other purposes. By way of example only, the cartridge 10 may be a power pack for an electric drill (not shown), with the remaining part of the energy generated by the cartridge 10 being used to power the drill.

As note above, this example does not include a discrete reactor where the dehydrogenation reaction is carried out. Instead, the reactor comprises a region contained within the chamber 12 in which the hydrogenated carrier 14 comes in contact with the heater 20 and the dehydrogenation catalyst 21.

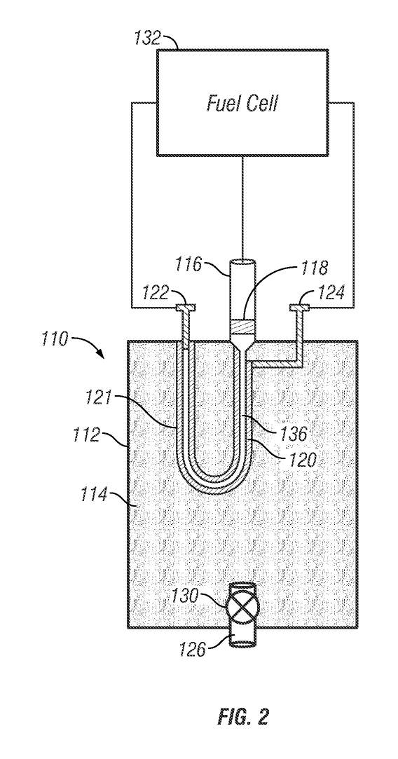

A second exemplary embodiment of a cartridge 110 is shown in FIG. 2. In this example, elements shared with the first example are represented by reference numerals increased by factors of 100. For example, the membrane 18 of the first example corresponds to the membrane 118 of the second example. In the interest of clarity, some features of this embodiment that are shared with the first embodiment are numbered in FIG. 2, but are not repeated in the specification.

In this example, the cartridge 110 includes a hollow heater 120 having an interior channel 136 in fluid communication with the hydrogen release conduit 116. Hydrogen dissolved within the carrier 114 is separated from the carrier 114 through selective absorption into the interior channel 136 of the heater 120. The dehydrogenation catalyst 121 also functions as a membrane for separation of the product hydrogen from the carrier 114. The heater 120 may be constructed of any suitable metal or metal alloy that absorbs hydrogen to form a metal hydride. Preferred materials include palladium or palladium-based alloys.

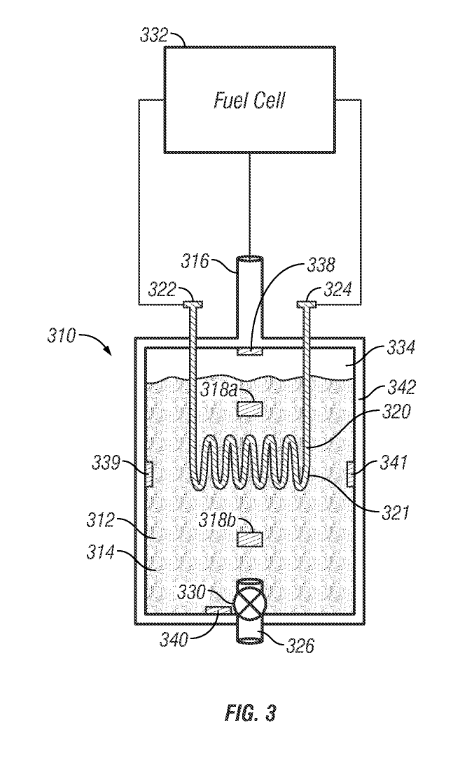

A third exemplary embodiment of a cartridge 310 is shown in FIG. 3. In this example, elements shared with the first example are represented by reference numerals increased by factors of 300. For example, the membrane 18 of the first example corresponds to the membrane 318 of the third example. In the interest of clarity, some features of this embodiment that are shared with the first embodiment are numbered in FIG. 3, but are not repeated in the specification.

In this example, the cartridge 310 is designed to operate in a multitude of orientations. The cartridge 310 includes multiple hydrogen release openings 338, 339, 340, 341 that are arranged around a perimeter of the cartridge 310 so that at least one hydrogen release opening 338, 339, 340, 341 is in contact with the hydrogen gas in the head space 334 of the chamber 312. A hydrogen collection channel 342 is in communication with each of the hydrogen release openings 338, 339, 340, 341 and the hydrogen release conduit 316, which enables hydrogen to flow from any of the hydrogen release openings 338, 339, 340, 341 to the fuel cell 332. The heater 320 is preferably positioned in the center of the chamber 312, so that it will be in contact with the carrier 314 when the cartridge 310 is in any orientation.

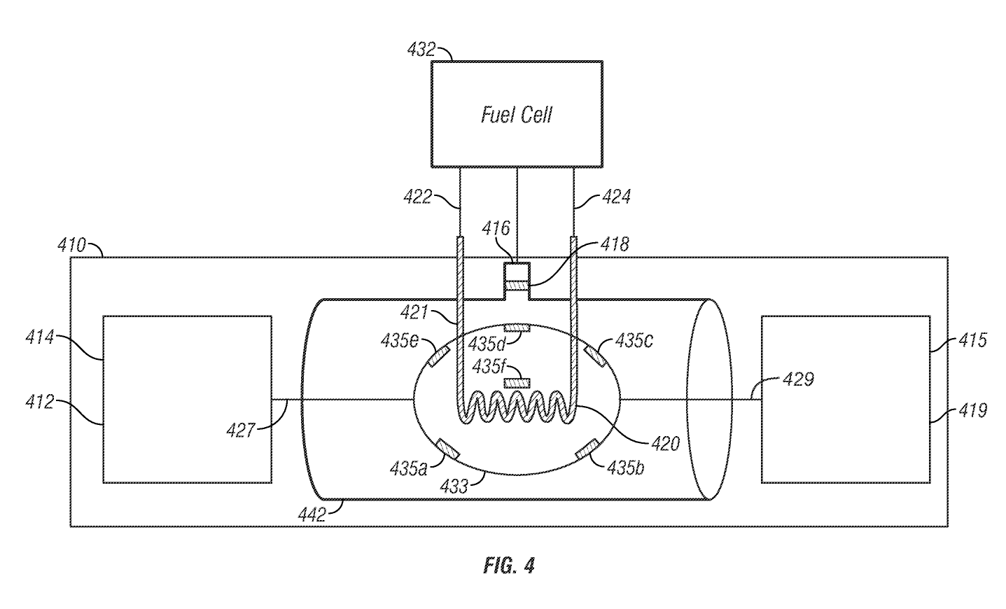

Another embodiment of the present invention is illustrated in FIG. 4. In this example, elements shared with the first example are represented by reference numerals increased by factors of 400. For example, the membrane 18 of the first example corresponds to the membrane 418 of the third example. In the interest of clarity, some features of this embodiment that are shared with the first embodiment are numbered in FIG. 4, but are not repeated in the specification.

In this example, a cartridge 410 has a chamber 412 with a hydrogenated carrier 414, a dehydrogenated carrier 415, and a capillary tube assembly 442 providing fluid communication between the hydrogenated carrier 414 and the dehydrogenated carrier 415.

The capillary tube assembly 442 may be insulated, infra-red (IR) reflective, or contoured, or porous to facilitate flow of fluid or gas. A first end of a first capillary tube 427 draws hydrogenated carrier 414 from the chamber 412 to the capillary tube assembly 442. A heater 420 is located inside the capillary tube assembly 442 and may be coated with the catalyst 421. The heater 420 may be a resistive heater, a heat-exchanger, sectioned and/or gas permeable. Additionally the heater 420 may comprise a secondary catalyst 421 located inside or outside of the heater 420 to facilitate thermal reactions. Accordingly, the capillary tube assembly 442 comprises a reactor that is external to the chamber 412.

The capillary tube assembly 442 may comprise a flow-through sphere 433 with a small coiled resistive heater 420 in the middle where the sphere 433 has multiple openings 435a-f and a mirrored interior. The purpose of the sphere 433 is to locally isolate the temperature of the catalyst 421 and fluid volume and yet permit omni-directional operation of the cartridge 410. The sphere 433 is preferably made of an insulating material and may include an IR reflective coating.

A first end of a second capillary tube 429 draws dehydrogenated carrier 415 from the sphere 433 and deposits the dehydrogenated carrier 415 into its own chamber 419, separate from the hydrogenated carrier 414.

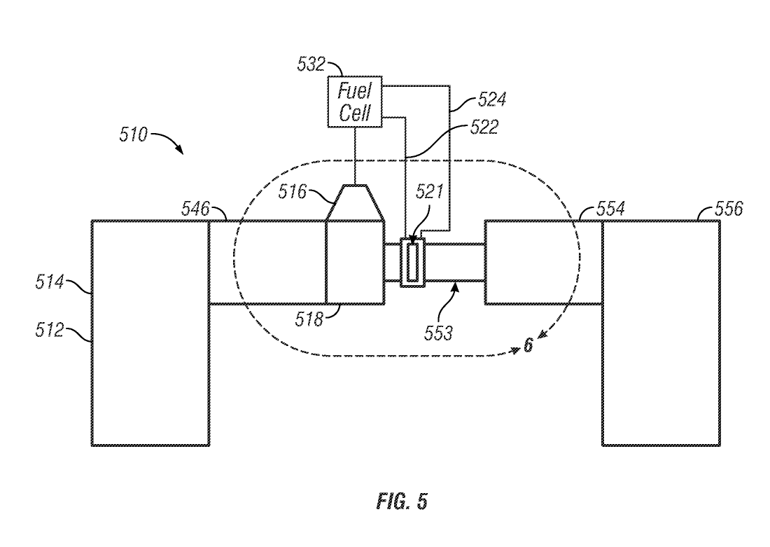

In another exemplary embodiment of the invention, illustrated in FIGS. 5 and 6, a chamber 512 includes a pump 546 to move a hydrogenated carrier 514 across a void 548, and then to a catalytic reactor to remove the hydrogen from the hydrogenated carrier 514. In this embodiment, the catalytic reactor is comprised of the pump 546, the void 548, a heater 520, and a funnel 552. The pump 546 may be a MEMS pump, piston-driven pump, hydraulic pump, or other suitable type of pump that can pump droplets of hydrogenated carrier 514 across the void 548. The pump 546 pumps the hydrogenated carrier 514 in a series of separate droplets.

The catalytic reactor includes the funnel 552 to catch the droplets of hydrogenated carrier 514 across the void 548. The droplets adhere to the surface of the funnel 552 through surface tension forces. The funnel 552 is coated with a dehydrogenation catalyst 521 on its surface. The funnel 552 is heated by the heater 520, thereby heating the surface of the funnel 552 and the dehydrogenation catalyst 521, resulting in the dehydrogenation of the droplets of hydrogenated carrier 514 upon or shortly after their impact with the outer surface of the funnel 552.

The carrier 514, now dehydrogenated, is then withdrawn by capillary action through a capillary 553 to the orifice of a second pump 554 for injection into a spent reservoir 556. The hydrogen that is released from the carrier 514 flows upward into a hydrogen release conduit 516 to a fuel cell 532, which is electrically coupled to the heater 520. The fuel cell 532 provides power to operate the heater 520.

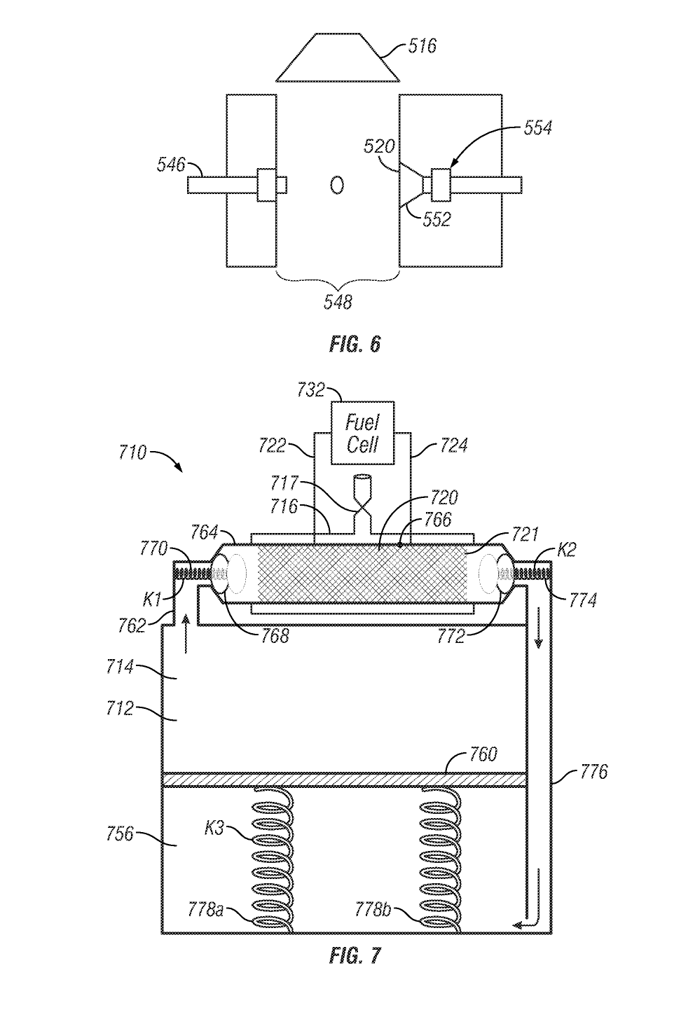

Another alternative embodiment of the present invention is a cartridge 710 illustrated in FIG. 7. The cartridge 710 includes a hydrogenated carrier 714 in a collapsible chamber 712. The chamber 712 includes a movable floor 760 that maintains only hydrogenated carrier 714 within the chamber 712 and forces the hydrogenated carrier 714 therein through an outlet port 762 into a conversion tube 764.

The conversion tube 764 includes a heater 720 and a dehydrogenation catalyst 721 that cooperate to remove hydrogen from the hydrogenated carrier 714 as the hydrogenated carrier 714 passes through the conversion tube 764. The conversion tube 764 includes a hydrogen-permeable membrane 766 that allows the disassociated hydrogen to pass out of the conversion tube 764 and into a hydrogen release conduit 716. Hydrogen release conduit 716 is in fluid communication with a throttling valve 717 that may be throttled between a fully open and a fully closed position in order to regulate the amount of hydrogen being released from the hydrogen release conduit 716. The throttling valve 717 also controls the rate of dehydrogenation of the hydrogenated carrier 714.

A spring-loaded conversion tube inlet valve 768 is used to selectively open/close fluid communication between the outlet port 762 and the conversion tube 764. The conversion tube inlet valve 768 includes a first spring 770 having a spring constant K1. The conversion tube inlet valve 768 is in a normally open (“NO”) position so that hydrogenated carrier 714 readily flows into the conversion tube 764. FIG. 7 illustrates the conversion tube inlet valve 768 in the NO position by broken lines.

A spring-loaded conversion tube outlet valve 772 is located at a far end of the conversion tube 764 from the spring-loaded conversion tube inlet valve 768 and allows the dehydrogenated carrier to pass out of the conversion tube 764 after its hydrogen has been removed. The conversion tube outlet valve 772 includes a second spring 774 having a spring constant K2, which is the same value as the spring constant K1. The conversion tube outlet valve 772 is in a normally open (“NO”) position so that dehydrogenated carrier readily flows out of the conversion tube 764 and into a dehydrogenated carrier passage 776. FIG. 7 illustrates the conversion tube outlet valve 772 in the NO position by broken lines.

Dehydrogenated carrier passage 776 is a vertical passage that discharges dehydrogenated carrier into a spent reservoir 756 that is located below the movable floor 760. Springs 778a, 778b move the floor 760 upward in response to hydrogenated carrier 714 leaving collapsible chamber 712 and to accommodate dehydrogenated carrier entering the spent reservoir 756. Springs 778a, 778b each have a spring constant K3 such that the total spring force (i.e., the sum of the force of the springs 778a, 778b shown in FIG. 7) is less than the force of first spring 770.

In operation, springs 778a, 778b force the floor 760 upward, which in turn, forces the hydrogenated carrier 714 through the outlet port 762, past the open conversion tube inlet valve 768, and into the conversion tube 764. As hydrogen is removed from hydrogenated carrier 714, the freed hydrogen increases pressure within the conversion tube 764. The increased pressure is sufficient to overcome the force of springs 770 and 774, closing valves 768 and 772.

With valves 768 and 772 closed, hydrogen is removed from the hydrogenated carrier 714 until the valve 717 is opened to allow enough hydrogen to flow through the valve 717 to reduce the pressure inside the conversion tube 764 so that valves 768 and 772 open. At that time, hydrogenated carrier 714 from the chamber 712 forces the dehydrogenated carrier from the conversion tube 764 through the conversion tube outlet valve 772, through the dehydrogenated carrier passage 776 and to the spent reservoir 756. The dehydrogenation process is repeated until all of the hydrogenated carrier 714 is dehydrogenated. Optionally, the valve 717 could be modulated in order to provide a means of controlling the pressure inside the conversion tube 764.

As such, an invention has been disclosed in terms of preferred embodiments and alternate embodiments thereof. Of course, various changes, modifications, and alterations from the teachings of the present invention may be contemplated by those skilled in the art without departing from the intended spirit and scope thereof. It is intended that the present invention only be limited by the terms of the appended claims.

1. An apparatus comprising:
a reactor;
a heater having a first portion that is located in the reactor;
a dehydrogenation catalyst that is affixed to the first portion of the heater;
a hydrogen release conduit in communication with the reactor;
a chamber containing a hydrogenated carrier; and
an energy source coupled to the heater.

2. The apparatus according to claim 1, further comprising means for engaging the hydrogenated carrier with the dehydrogenation catalyst.

3. The apparatus according to claim 2, wherein the means for engaging comprises a collapsible bladder.

4. The apparatus according to claim 2, wherein the means for engaging comprises a pump.

5. The apparatus according to claim 2, wherein a capillary comprises both the reactor and the means for engaging.

6. The apparatus according to claim 1, wherein the heater comprises a gas permeable and liquid impermeable material surrounding an interior channel.

7. The apparatus according to claim 6, wherein the interior channel is in communication with the hydrogen release conduit.

8. The apparatus according to claim 1, wherein the energy source comprises electricity from a fuel cell.

9. The apparatus according to claim 1, wherein the energy source comprises heat from a chemical reaction.

10. The apparatus according to claim 1, wherein the reactor comprises a plurality of hydrogen release openings located around a perimeter of the reactor, each of the plurality of hydrogen release openings being in communication with the hydrogen release conduit.

11. The apparatus according to claim 1, further comprising a spent carrier reservoir in communication with the hydrogenated carrier, the spent carrier reservoir adapted to receive the hydrogenated carrier after the hydrogenated carrier has passed through the reactor.

12. The apparatus according to claim 1, wherein the hydrogenated carrier is adapted to release hydrogen only when heated to a temperature greater than 100 degrees Celsius.

13. The apparatus according to claim 1, wherein the hydrogenated carrier is selected from the group consisting of: large polycyclic aromatic hydrocarbons, polycyclic aromatic hydrocarbons with nitrogen heteroatoms, polycyclic aromatic hydrocarbons with oxygen heteroatoms, polycyclic aromatic hydrocarbons with alkyl, alkoxy, ketone, ether or polyether substituents, pi-conjugated molecules comprising 5 membered rings, pi-conjugated molecules comprising six and five membered rings with nitrogen or oxygen hetero atoms, and extended pi-conjugated organic polymers.

14. The apparatus according to claim 1, wherein the reactor comprises a region located within the chamber.

15. The apparatus according to claim 1, wherein the reactor is external to the chamber.

16. An apparatus comprising:
a reactor containing a heating element and a dehydrogenation catalyst;
a chamber containing a hydrogenated carrier;
a hydrogen release conduit in communication with the reactor and a fuel cell; and
an electrical connection between the fuel cell and the heating element.

17. The apparatus according to claim 16, wherein the hydrogenated carrier is selected from the group consisting of: large polycyclic aromatic hydrocarbons, polycyclic aromatic hydrocarbons with nitrogen heteroatoms, polycyclic aromatic hydrocarbons with oxygen heteroatoms, polycyclic aromatic hydrocarbons with alkyl, alkoxy, ketone, ether or polyether substituents, pi-conjugated molecules comprising 5 membered rings, pi-conjugated molecules comprising six and five membered rings with nitrogen or oxygen hetero atoms, and extended pi-conjugated organic polymers.

18. The apparatus according to claim 16, further comprising means for engaging the hydrogenated carrier with the dehydrogenation catalyst.

19. A method comprising the steps of:
a) supplying a hydrogenated carrier to a reactor containing a dehydrogenating catalyst and a heater; and
b) dehydrogenating the hydrogenated carrier by heating the heater to a temperature above 100 degrees Celsius in the presence of a dehydrogenating catalyst.

20. The method according to claim 20, wherein step b) further comprises dehydrogenating the hydrogenated carrier by heating the heater using electricity from a fuel cell.
